(19) United States
(12) Patent Application Publication
(10) Pub. No.: US 2012/0046888 A1
(43) Pub. Date: Feb. 23, 2012

(54) ANALYSIS APPARATUS AND ANALYSIS METHOD

(75) Inventor: Koichi SHIMIZU, Kawasaki (JP)

(73) Assignee: FUJITSU LIMITED, Kawasaki (JP)

(21) Appl. No.: 13/113,449

(22) Filed: May 23, 2011

(30) Foreign Application Priority Data
Aug. 18, 2010 (JP) 2010-183284

(51) Int. Cl. G06F 19/00

(52) U.S. Cl. 702/57

(57) ABSTRACT

An analysis apparatus analyzes the properties of an object to be analyzed. Specifically, the analysis apparatus receives an input of property information on an object to be analyzed and calculates, in accordance with the property information on the input object to be analyzed, an average value of magnetization vectors allocated to each micro-region that is obtained by dividing the object to be analyzed into regions. Then, by using the calculated average value of the magnetization vectors and an equation of a magnetic field that is a governing equation of a vector potential, the analysis apparatus calculates the vector potential obtained after a predetermined time has elapsed.

### CROSS-REFERENCE TO RELATED APPLICATION

This application is based upon and claims the benefit of priority of the prior Japanese Patent Application No. 2010-183284, filed on Aug. 18, 2010, the entire contents of which are incorporated herein by reference.

### FIELD

An embodiment of the invention discussed herein is directed to an analysis apparatus and an analysis method.

### BACKGROUND

Conventional analysis apparatuses simulate magnetic fields generated in magnetic materials by modeling the properties of the magnetic materials and by analyzing the properties of the modeled magnetic materials. For example, the analysis apparatuses model the magnetic hysteresis of a magnetic material in accordance with both an M-H curve, which indicates the relation between magnetization M of the magnetic material and an external magnetic field H of the magnetic material, and the coercive force Hc of the magnetic material. Such analysis apparatuses simulate the property of the magnetic material by analyzing the modeled magnetic hysteresis.

As illustrated in FIG. 17, in some cases, the magnetization M of a magnetic material may vary in such a manner that curves called minor loops are made within the M-H curves. However, the analysis apparatuses do not simulate the minor loops if the analysis apparatuses, in accordance with the previously determined M-H curve and the coercive force Hc, model the magnetic hysteresis of the magnetic material, thus reducing the accuracy of the modeling of the magnetic material. FIG. 17 is a schematic diagram illustrating minor loops.

In such a case, to accurately model the properties of the magnetic materials, there is a known technology, called micro-magnetization analysis, for modeling the properties of the magnetic materials by dividing the magnetic materials into multiple regions and calculating the magnetization state in each divided region.

Specifically, an analysis apparatus that performs a micro-magnetization analysis uses a micro-magnetization vector m in each region of the divided magnetic material. Then, the analysis apparatus solves, as simultaneous equations, both the Landau Lifshitz Gilbert (LLG) equation corresponding to the equation of motion of a micro-magnetization vector m and the equation of a magnetic field representing an external magnetic field H given by a micro-magnetization vector m. More specifically, by solving both the LLG equation and the equation of the magnetic field as the micro-magnetization vector m and the external magnetic field H evolve over time, the analysis apparatus simulates, with high accuracy, the properties of the magnetic materials, including the minor loops.

For example, by using the equation of the magnetic field, the analysis apparatus calculates an external magnetic field Hₜ given by a micro-magnetization vector mₜ at a time t. Then, by using both the calculated external magnetic field Hₜ and the LLG equation, the analysis apparatus calculates the value of a micro-magnetization vector m_{t+Δt} at a time t+Δt for which the time has evolved by At from the time t. By repeatedly performing this calculation, the analysis apparatus simulates the properties of the magnetic materials that temporally vary.

Furthermore, if simultaneous equations include an equation that indicates a non-stationary value, by using the shortest time scale in the time scale used with each equation, the analysis apparatus solves equations by evolving, over time, the non-stationary value. Here, the micro-magnetization vector m has a non-stationary value in terms of the external magnetic field H, and the time scale that is used with the LLG equation is shorter than that used with the equation of the magnetic field.

Accordingly, by using the time scale used with the LLG equation, the analysis apparatus evolves, over time, both the micro-magnetization vector m and the external magnetic field H. For example, if the time scale used with the LLG equation is approximately 10⁻¹² seconds, the analysis apparatuses calculates, from the external magnetic field Hₜ at the time t, a micro-magnetization vector at a time t+10⁻¹² and then calculates, from the calculated micro-magnetization vector, an external magnetic field at a time t+10⁻¹².

However, with the above-described technology that is used for the micro-magnetization analysis, using the time scale used with the LLG equation, both the micro-magnetization vector m and the external magnetic field H are made to evolve over time; therefore, there is a problem in that the period of time for simulating the properties of the magnetic materials is limited to a short period of time.

For example, if the time scale used with the LLG equation is 10⁻¹² seconds, the analysis apparatus evolves both the micro-magnetization vector m and the external magnetic field H over time at approximate time intervals of 10⁻¹² seconds. Accordingly, even when the analysis apparatus calculates for a long period of time, it only simulates the properties of the magnetic materials for approximately 10⁻⁶ seconds. Furthermore, if the analysis apparatus simulates the properties of the magnetic materials for several seconds, it cannot complete the calculation in a predetermined period of time; therefore, the analysis apparatus cannot simulate the properties of the magnetic materials for several seconds.

To use a micro-magnetization analysis for a large magnetic material, it is conceivable to use a technology for dividing the magnetic materials into a plurality of meshes and using, as a magnetization vector, the average value of a plurality of micro-magnetization vectors m that are included in the meshes. However, analysis apparatuses that use such a technology evolve, over time, both the micro-magnetization vector m and the external magnetic field H using the time scale used with the LLG equation. Accordingly, the period of time for simulating the properties is limited to a short period of time; therefore, it is impossible to simulate the properties of the magnetic materials for several seconds.

According to an aspect of the disclosed technology, it is possible to simulate the properties of magnetic materials for a long period of time.

Patent Document: Japanese Laid-open Patent Publication No. 2008-275403

### SUMMARY

According to an aspect of an embodiment of the invention, an analysis apparatus includes a receiving unit that receives a property information on an object to be analyzed; and a vector potential calculating unit that calculates an average value of a plurality of magnetization vectors allocated to each region of the object that is obtained by dividing the object to be analyzed in accordance with the received property information of the object to be analyzed, and calculates a vector potential obtained after a predetermined time has elapsed by using the calculated average value of the magnetization vectors and an equation of a magnetic field that is a governing equation of a vector potential.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram illustrating an information processing apparatus according to a first embodiment;

FIG. 2 is a schematic diagram illustrating an example of a read process performed on a mesh;

FIG. 3 is a schematic diagram illustrating an example of a process for setting analysis conditions;

FIG. 4 is a schematic diagram illustrating an example of a process for setting the properties of an object to be analyzed;

FIG. 5 is a schematic diagram illustrating a calculation in which both the LLG equation and an equation of a stationary magnetic field are evolved over time;

FIG. 6 is a schematic diagram illustrating calculation in which both the LLG equation and an equation of a non-stationary magnetic field are evolved over time;

FIG. 7 is a schematic diagram illustrating an example of simulating minor loops using a micro-magnetization analysis;

FIG. 8 is a schematic diagram illustrating a magnetic field gradient;

FIG. 9 is a schematic diagram illustrating a saturation magnetic field;

FIG. 10 is a schematic diagram illustrating an example of output results;

FIG. 11 is a schematic diagram illustrating an example of a process for evolving time by using an explicit expression M;

FIG. 12 is a schematic diagram illustrating an example of a process for evolving time by using an implicit expression M;

FIG. 13 is a flowchart illustrating the flow of a process for evolving time by using the explicit expression M;

FIG. 14 is a flowchart illustrating the flow of a process for evolving time by using the implicit expression M;

FIG. 15 is a flowchart illustrating the flow of a process that uses a magnetic field gradient to perform time evolution;

FIG. 16 is a functional block diagram illustrating a computer that executes an analysis program; and

FIG. 17 is a flowchart illustrating minor loops.

### DESCRIPTION OF EMBODIMENTS

Preferred embodiments of the present invention will be explained with reference to accompanying drawings. In the following, each embodiment will be described as an information processing apparatus that includes the analysis apparatus disclosed in the present invention. Furthermore, in the following description, a micro-magnetization vector m, an average value M of the micro-magnetization vectors m, an external magnetic field H, and a vector potential A are assumed to be vectors.

[a] First Embodiment

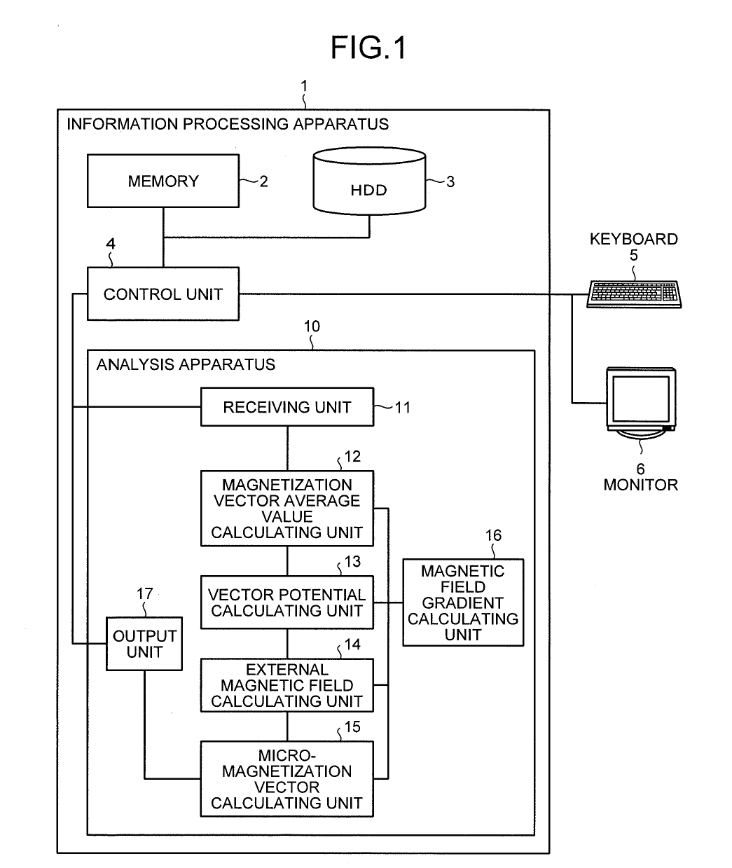

In a first embodiment, an example of an information processing apparatus that includes an analysis apparatus will be described with reference to FIG. 1. FIG. 1 is a schematic diagram illustrating the information processing apparatus according to the first embodiment. The information processing apparatus according to the first embodiment is a computer that simulates, in accordance with an initial value of a micro-magnetization vectors that is input from outside, the properties of a magnetic material.

In the example illustrated in FIG. 1, an information processing apparatus 1 includes a memory 2, a hard disk drive (HDD) 3, a control unit 4, and an analysis apparatus 10. Furthermore, the information processing apparatus 1 is connected to a keyboard 5 and a monitor 6. The memory 2 is a storing unit that temporarily stores therein arbitrary information. The HDD 3 is a storing unit that stores therein arbitrary information. The keyboard 5 is an input device used for inputting property information on an object to be analyzed or inputting settings of the analysis method. The monitor 6 is a display that displays a screen for inputting the property information on the object to be analyzed or inputting analysis results.

The control unit 4 controls the memory 2, the HDD 3, and the analysis apparatus 10 that are included in the information processing apparatus 1. Furthermore, the control unit 4 displays, on the monitor 6, setting screens for dividing the magnetic material into meshes, for analysis conditions, and for the properties of an object to be analyzed. The control unit 4 transmits, to the analysis apparatus 10, various kinds of information that is set by a user. Furthermore, if the control unit 4 obtains an analysis result from the analysis apparatus 10, the control unit 4 displays the obtained analysis result on the monitor 6.

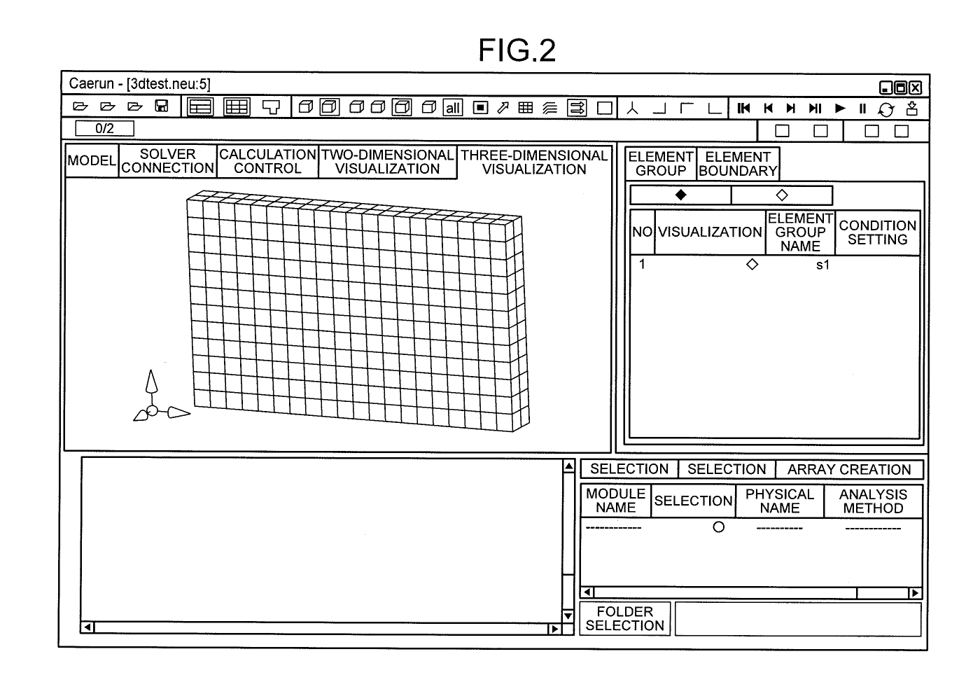

For example, as in the example illustrated in FIG. 2, the control unit 4 displays a setting screen for dividing the magnetic material into meshes, which is an object to be analyzed, on the monitor 6. FIG. 2 is a schematic diagram illustrating an example of a read process performed on a mesh. A user of the information processing apparatus 1 divides, via the setting screen illustrated in FIG. 2, the magnetic material into meshes and sets micro-magnetization vectors m that are allocated to each of the meshes.

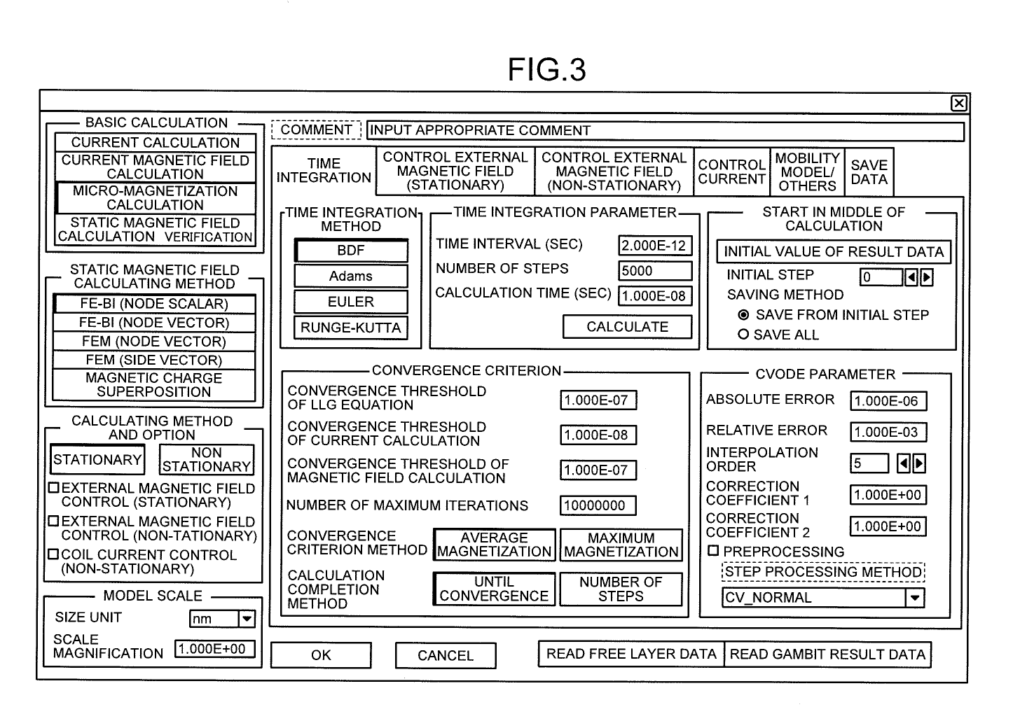

Furthermore, as in the example illustrated in FIG. 3, the control unit 4 displays the setting screen for the analysis conditions on the monitor 6. FIG. 3 is a schematic diagram illustrating an example of a process for setting analysis conditions. In the example illustrated in FIG. 3, the control unit 4 displays, the setting screen for the selection of a basic calculation, a static magnetic field calculating method, a calculating method, and the selection of stationary or non-stationary state; the model scale of the magnetic material; a time integration method; various parameters; and the like on the monitor 6. Furthermore, in the example illustrated in FIG. 3, the control unit 4 displays, the setting screen for convergence criterion, the CVODE (solves initial value problems for an ordinary differential equation) parameter; and the like on the monitor 6.

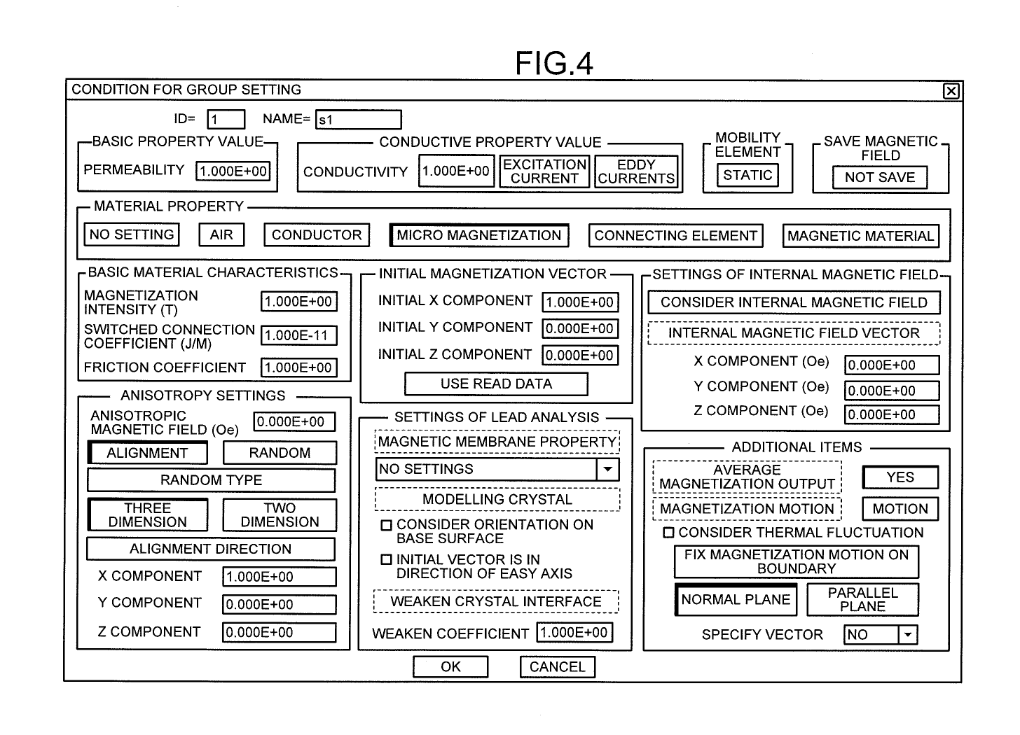

Furthermore, as in the example illustrated in FIG. 4, the control unit 4 displays, the setting screen for property information on an object to be analyzed on the monitor 6. FIG. 4 is a schematic diagram illustrating an example of a process for setting the properties of an object to be analyzed. In the example illustrated in FIG. 4, the control unit 4 displays, the setting screen for a basic property value, a conductive property value, a moving element, storing of the magnetic field, material properties, basic material characteristics, settings of the anisotropy, initial magnetization vectors, settings of the lead analysis, settings of the internal magnetic field, additional items, and the like on the monitor 6.

Then, if a user sets micro-magnetization vectors m, analysis conditions, and property information on an object to be analyzed, the control unit 4 transmits each piece of set information to the analysis apparatus 10.

Referring back to FIG. 1, the analysis apparatus 10 receives an input of property information on an object to be analyzed. Furthermore, the analysis apparatus 10 calculates, in accordance with the received property information on the object to be analyzed, the average value M (hereinafter, referred to as an “average value M”) of a plurality of micro-magnetization vectors m that are allocated to the object to be analyzed. Then, using both the calculated average value M and an equation of the magnetic field that is a governing equation of a vector potential A, the analysis apparatus 10 calculates a vector potential A obtained after a predetermined time has elapsed.

In the following, a calculating process performed by the analysis apparatus 10 will be described in detail. The first thing described in the following description will be a process performed by a conventional information processing apparatus in which the Landau Lifshitz Gilbert (LLG) equation, which is an equation of motion of a micro-magnetization vector m, and an equation of the magnetic field representing the external magnetic field H are simultaneously solved. Then, a process performed by the analysis apparatus 10 will be described.

The LLG equation, which is the equation of motion of a micro-magnetization vector m, can be given by Equation (1) below:

$$\frac{\partial m}{\partial t} = - γ m \times {H}_{eff} + α ( m \times \frac{\partial m}{\partial t} ) \qquad ( 1 )$$

where m is the micro-magnetization vector and γ is the gyromagnetic ratio. Furthermore, in Equation (1), H_{eff} is the effective magnetic field given by the micro-magnetization vector and is specifically given by Equation (2) below:

H_{eff}=H_{mag}+Hₑₓ+Hₐₙᵢₛₒ (2)

where H_{mag} is the magnetic field formed by the micro-magnetization vector m. Furthermore, Hₑₓ is the switched connection magnetic field. Furthermore, Hₐₙᵢₛₒ is the anisotropic magnetic field.

In the following, an equation of the magnetic field representing the external magnetic field H will be described. The equation of the magnetic field representing the external magnetic field H includes both the equation of the stationary magnetic field and the equation of the non-stationary magnetic field. The equation of the stationary magnetic field includes both a governing equation of a scalar potential and a governing equation of a vector potential. Specifically, the governing equation of the scalar potential can be given by Equation (3) and Equation (4) below. In Equation (3), Δ is the Laplace operator, φ is the scalar potential, and ∇ is the vector differential operator.

Δφ=∇·m (3)

H_{mag}=−∇φ (4)

Furthermore, the governing equation of the vector potential can be given by Equation (5) and Equation (6) below. In Equation (5), A is the vector potential, μ₀ is the vacuum permeability, and J is the vector representing the excitation current.

$$\begin{matrix}∇ \times ∇ \times A = {μ}_{0} J + ∇ \times m & ( 5 ) \\ {H}_{mag} = \frac{1}{{μ}_{0}} ∇ \times A & ( 6 )\end{matrix}$$

The governing equation of the scalar potential can take into consideration the effect of the magnetic field generated by the excitation current, whereas the governing equation of the vector potential can take into consideration the effect of the magnetic field generated by the excitation current.

Furthermore, the equation of the non-stationary magnetic field can be given by Equation (7) below. In Equation (7), σ is the conductivity. The equation of the non-stationary magnetic field is an equation taking into consideration the contribution of eddy currents and is represented as the governing equation of the vector potential A.

$${μ}_{0} σ \frac{\partial A}{\partial t} + ∇ \times ∇ \times A = {μ}_{0} J + ∇ \times m \qquad ( 7 )$$

When simultaneously solving the LLG equation and the governing equation of the stationary scalar potential, the conventional information processing apparatus solves the LLG equation and the governing equation of the stationary scalar potential by treating Equation (1) to Equation (4) as simultaneous equations and then solving the LLG equation and the governing equation of the stationary scalar potential as the micro-magnetization vector m and the external magnetic field H evolve over time. Furthermore, when simultaneously solving the LLG equation and the governing equation of the stationary vector potential, the conventional information processing apparatus solves them by treating Equation (1), Equation (2), Equation (5), and Equation (6) as simultaneous equations and then solving them as the micro-magnetization vector m and the external magnetic field H evolve over time.

Furthermore, when simultaneously solving the LLG equation and governing equation of the non-stationary vector potential, the conventional information processing apparatus solves them by treating Equation (1), Equation (2), Equation (6), and Equation (7) as simultaneous equations and then solving them as the micro-magnetization vector m and the external magnetic field H evolve over time.

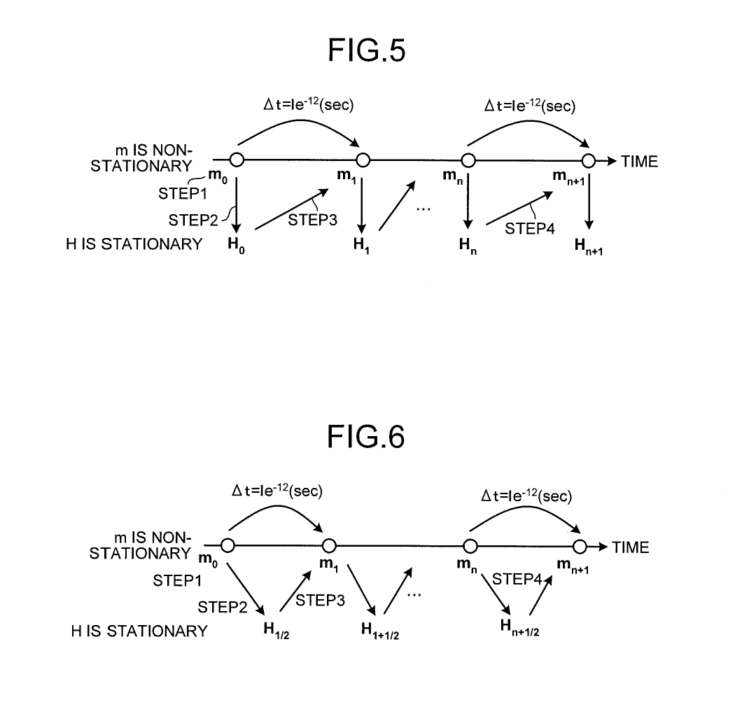

In the following, there will be a description with reference to FIG. 5 of a process, performed by the conventional information processing apparatus, in which the LLG equation and the equation of the stationary magnetic field are solved by treating them as simultaneous equations as the micro-magnetization vector m and the external magnetic field H evolve over time. FIG. 5 is a schematic diagram illustrating a calculation in which both the LLG equation and an equation of a stationary magnetic field are evolved over time. In the example illustrated in FIG. 5, it is assumed that the conventional information processing apparatus solves the equations, using an explicit method, as the micro-magnetization vector m and the external magnetic field H evolve over time.

First, the conventional information processing apparatus obtains, as an initial value, a micro-magnetization vector m₀ at a time 0 (Step 1 in FIG. 5). Then, the conventional information processing apparatus calculates, using the micro-magnetization vector m₀ at the time 0, an external magnetic field H₀ at the time 0 (Step 2 in FIG. 5). Subsequently, by using the calculated external magnetic field H₀ as an effective magnetic field H_{eff} given by the micro-magnetization vector m, the conventional information processing apparatus calculates a micro-magnetization vector m₁ at the subsequent time step, (Step 3 in FIG. 5).

Specifically, the conventional information processing apparatus calculates the external magnetic field Hₙ from the micro-magnetization vector mₙ and then calculates, from the calculated external magnetic field Hₙ, the micro-magnetization vector mₙ₊₁ obtained after a predetermined time has elapsed. By repeatedly performing such a series of calculations, the conventional information processing apparatus calculates as the micro-magnetization vector m and the external magnetic field H evolve over time (Step 4 in FIG. 5).

In the following, there will be a description with reference to FIG. 6 of a process, performed by the conventional information processing apparatus, in which the LLG equation and the equation of the non-stationary magnetic field both are solved by treating them as simultaneous equations as the micro-magnetization vector m and the external magnetic field H evolve over time. FIG. 6 is a schematic diagram illustrating calculation in which both the LLG equation and an equation of a non-stationary magnetic field are evolved over time. In the example illustrated in FIG. 6, it is assumed that the conventional information processing apparatus uses an implicit method to solve the equations as the micro-magnetization vector m and the external magnetic field H evolve over time.

First, the conventional information processing apparatus obtains, as an initial value, a micro-magnetization vector m₀ at a time 0 (Step 1 in FIG. 6). Then, the conventional information processing apparatus calculates, using the micro-magnetization vector m₀, an external magnetic field H_{1/2} in which the time step is advanced by a half step (Step 2 in FIG. 6). Subsequently, the conventional information processing apparatus calculates, using the external magnetic field H_{1/2}, a micro-magnetization vector m₁ in which a time step is further advanced by a half step (Step 3 in FIG. 6). By repeatedly performing such a series of calculations, the conventional information processing apparatus sequentially calculates as the micro-magnetization vector m and the external magnetic field H evolve over time (Step 4 in FIG. 6).

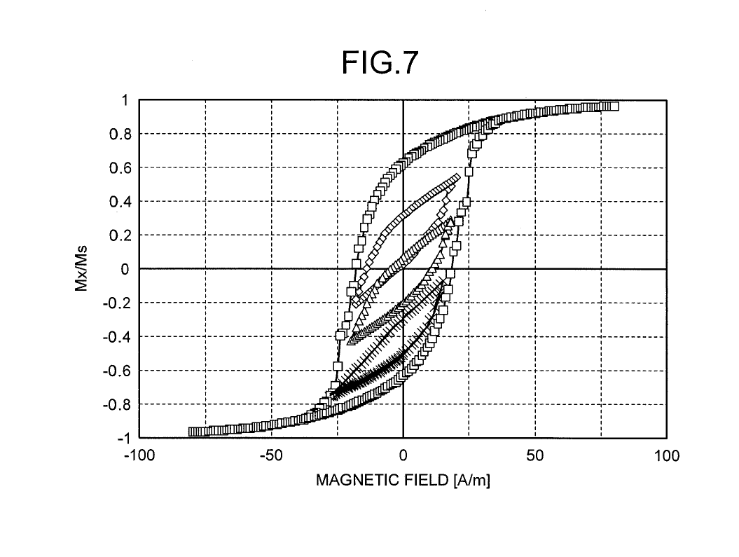

In this way, the conventional information processing apparatus treats the LLG equation and the equation of the magnetic field as simultaneous equations and simultaneously solves the equations by evolving them over time so that the apparatus simulates the properties of the magnetic material. For example, as illustrated in FIG. 7, the conventional information processing apparatus simulates minor loops produced within the M-H curves. FIG. 7 is a schematic diagram illustrating an example of simulating minor loops using a micro-magnetization analysis.

However, as described above, the conventional information processing apparatus solves the LLG equation and the equation of the magnetic field by making both the micro-magnetization vector m and the external magnetic field H evolve over time using the time scale used with the LLG equation. Accordingly, the conventional information processing apparatus limits the period of time for simulating the properties of the magnetic material to a short period of time. For example, in the examples illustrated in FIGS. 5 and 6, the conventional information processing apparatus evolves time only by 10⁻¹² seconds for each single time step. Accordingly, the conventional information processing apparatus cannot simulate the properties of the magnetic material for several seconds.

In the following, a calculating process performed by the analysis apparatus 10 according to the first embodiment will be described. First, an explicit method will be described in which equations are simultaneously solved by explicitly representing the average value M of the micro-magnetization vectors m. The analysis apparatus 10 calculates the average value M of the micro-magnetization vectors m allocated to the object to be analyzed (hereinafter, referred to as “average value M”) using Equation (8) below:

$$M = \frac{1}{N} {\sum }_{i = 1}^{N} {m}_{i} \qquad ( 8 )$$

At this stage, if the average value M of the micro-magnetization vectors m is explicitly represented by using the vector potential A, it is possible to obtain Equation (9) below. In Equation (9), Aⁿ⁺¹ is the vector potential A at the n+1^{th} time step. Furthermore, Mⁿ is the average value M at the n^{th} time step.

$$( \frac{{μ}_{0} σ}{Δ t} - {∇}^{2} ) {A}^{n + 1} = \frac{{μ}_{0} σ}{Δ t} + {A}^{n} + ∇ \times {M}^{n} \qquad ( 9 )$$

Then, if Equation (9) is transformed using an inverse matrix, it is possible to obtain Equation (10) below:

$${A}^{n + 1} = {( \frac{{μ}_{0} σ}{Δ t} - {∇}^{2} )}^{- 1} ( \frac{{μ}_{0} σ}{Δ t} {A}^{n} + ∇ \times {M}^{n} ) \qquad ( 10 )$$

Specifically, if the average value M is explicitly represented, the analysis apparatus 10 solves Equation (9) from the average value Mⁿ at the n^{th} time step and calculates, in a single calculation, the vector potential Aⁿ⁺¹ at the n+1^{th} time step.

Because the time scale in which the average value M varies is much shorter than the time scale in which the vector potential A varies, the average value M can be assumed to be stationary during a period of time in which the vector potential Aⁿ changes to Aⁿ⁺¹. Specifically, the average value Mⁿ can be assumed to be in the stationary state with respect to an external magnetic field Hⁿ⁺¹ calculated from Aⁿ⁺¹.

As a result, because, in the calculation performed as the vector potential Aⁿ evolves over time by Aⁿ⁺¹, the average value M can be assumed to be in the stationary state, the analysis apparatus 10 can evolve the LLG equation over time for a long time scale over which the equation of the magnetic field is made to evolve. Specifically, because the analysis apparatus 10 calculates, from the average value Mⁿ, the vector potential Aⁿ⁺¹ obtained after a predetermined time has elapsed, the analysis apparatus 10 evolves both the vector potential A and the average value M over time for a long time scale over which the vector potential A evolve.

Here, the time scale over which the vector potential A is made to evolve is, for example, approximately 10⁻⁶ seconds. Furthermore, the time scale over which the micro-magnetization vector m is made to evolve over time is, for example, approximately 10⁻¹² seconds. Specifically, because the analysis apparatus 10 evolves the micro-magnetization vector m and the vector potential A over time for a long time scale, the analysis apparatus 10 can simulate the properties of the magnetic material over a long period of time.

In the following, if the analysis apparatus 10 calculates the vector potential Aⁿ⁺¹ using the average value Mⁿ, the analysis apparatus 10 calculates the external magnetic field Hⁿ⁺¹ using the calculated vector potential Aⁿ⁺¹, Equation (11), and Equation (12) below:

$$\begin{matrix}{B}^{n + 1} = ∇ \times {A}^{n + 1} & ( 11 ) \\ {H}^{n + 1} = \frac{1}{{μ}_{0}} {B}^{n + 1} & ( 12 )\end{matrix}$$

Then, the analysis apparatus 10 uses Equation (1) with the calculated external magnetic field H¹⁺¹ and then calculates the average value Mⁿ⁺¹. If the analysis apparatus 10 further evolves the average value Mⁿ⁺¹ over time, the analysis apparatus 10 repeats the process for sequentially solving Equation (10) to Equation (12) and calculates the average value Mⁿ⁺² at the subsequent time step.

At this stage, if the time intervals for evolving the simultaneous equations over time are large, to avoid the degradation of the calculation accuracy, the analysis apparatus 10 performs a calculation using an implicit method, in which the average value M is implicitly represented and both the average value M and the vector potential A are made to evolve over time. For example, if the vector potential A and the average value M are represented using a central difference with respect to time, Equation (13) below is given:

$${μ}_{0} σ \frac{{A}^{n + 1} - {A}^{n}}{Δ t} - \frac{{∇}^{2} ( {A}^{n} + {A}^{n + 1} )}{2} = \frac{∇ \times ( {M}^{n} + {M}^{n + 1} )}{2} \qquad ( 13 )$$

If the average value M is implicitly treated, a calculation is repeatedly performed, using Aⁿ⁺¹₁=Aⁿ⁺¹₀+δA, until δA becomes “0” or until δA converges to a predetermined threshold ε or below. Specifically, the analysis apparatus 10 treats a value obtained by adding Aⁿ⁺¹₀ to an increment δA of the vector potential A as a new vector potential Aⁿ⁺¹₁; calculates, using the vector potential Aⁿ⁺¹₁, an average value M₁; and then calculates a new δA using the calculated M₁. Then, the analysis apparatus 10 repeatedly performs a series of calculations until the calculated new δA becomes “0” or it converges to a predetermined threshold ε or below.

Here, it is assumed that Aⁿ⁺¹₀ represents the vector potential Aⁿ⁺¹ that has not been subjected to the repeated calculations for converging δA. In the following description, it is assumed that Aⁿ⁺¹ᵢ represents the calculated vector potential Aⁿ⁺¹ that is obtained after the repeated calculations for converging δA are performed “i” times.

If Aⁿ⁺¹=Aⁿ⁺¹+δA is used with Equation (13) and Equation (13) and is represented in the nonlinear and non-stationary incremental modes, Equation (14) below can be obtained:

$${μ}_{0} σ \frac{( {A}^{n + 1} + δ A ) - {A}^{n}}{Δ t} - \frac{{∇}^{2} ( {A}^{n} + ( {A}^{n + 1} + δ A ) )}{2} = \frac{∇ \times ( {M}^{n} + {M}^{n + 1} )}{2} \qquad ( 14 )$$

Furthermore, if Equation (14) is transformed to a linear equation of δA, Equation (15) below can be obtained:

$$( \frac{{μ}_{0} σ}{Δ t} - \frac{1}{2} {∇}^{2} ) δ A = \frac{{μ}_{0} σ ( {A}^{n + 1} - {A}^{n} )}{Δ t} + \frac{{∇}^{2} ( {A}^{n} + {A}^{n + 1} )}{2} + \frac{∇ \times ( {M}^{n} + {M}^{n + 1} )}{2} \qquad ( 15 )$$

Accordingly, the increment δA of the vector potential A can be given by Equation (16) below:

$$δ A = - {( \frac{{μ}_{0} σ}{Δ t} - \frac{1}{2} {∇}^{2} )}^{- 1} [ \frac{{μ}_{0} σ ( {A}^{n + 1} - {A}^{n} )}{Δ t} + \frac{{∇}^{2} ( {A}^{n} + {A}^{n + 1} )}{2} + \frac{∇ \times ( {M}^{n} + {M}^{n + 1} )}{2} ] \qquad ( 16 )$$

By using the average value Mⁿ in Equation (16), the analysis apparatus 10 calculates δA and calculates, from the calculated δA, new Aⁿ⁺¹₁=Aⁿ⁺¹₀+δA. Then, the analysis apparatus 10 calculates, from the new Aⁿ⁺¹₁ using Equation (13), the average value M₁ and calculates new δA from the calculated average value M₁. Furthermore, the analysis apparatus 10 calculates, from the calculated δA, Aⁿ⁺¹₂=Aⁿ⁺¹₁+δA. By repeatedly performing the calculations until δA becomes “0” or δA converges to a predetermined threshold ε or below, the analysis apparatus 10 can evolve both the average value M and the vector potential A over time.

As described above, because the time scale in which the average value M varies is much shorter than the time scale in which the vector potential A varies, the average value M can be assumed to be stationary during a period of time in which the vector potential Aⁿ changes to Aⁿ⁺¹. Specifically, in the repeated calculations from Aⁿ⁺¹₀ to Aⁿ⁺¹ₙ, the average value Mⁿ can be assumed to be in the stationary state with respect to the external magnetic field Hⁿ⁺¹.

As a result, in the repeated calculations performed as the vector potential Aⁿ evolves over time by Aⁿ⁺¹, the analysis apparatus 10 can evolve both the vector potential A and the micro-magnetization vector m over time for a long time scale over which the vector potential A evolves.

In the following, a calculating method will be described in which, when calculations are repeatedly performed using Equation (15), a gradient of a governing equation is used to speed up the convergence of the increment δA. For example, if a term taking into consideration the gradient of the average value M is added to Equation (15), Equation (17) below is obtained.

$$( \frac{{μ}_{0} σ}{Δ t} - \frac{1}{2} {∇}^{2} + \frac{1}{2} \frac{\partial }{\partial A} ∇ \times {M}^{n} ) δ A = - \frac{{μ}_{0} σ ( {A}^{n + 1} - {A}^{n} )}{Δ t} + \frac{{∇}^{2} ( {A}^{n} + {A}^{n + 1} )}{2} + \frac{∇ \times ( {M}^{n} + {M}^{n + 1} )}{2} \qquad ( 17 )$$

At this stage, if variable transformation is performed on the differentiation of the average value M, Equation (18) below is obtained.

$$\begin{matrix}\frac{\partial }{\partial A} ∇ \times M = \frac{\partial B}{\partial A} \frac{\partial }{\partial B} ∇ \times M \\ = \frac{\partial B}{\partial A} ∇ \times \frac{\partial M}{\partial B} = \frac{1}{{μ}_{0}} \frac{\partial B}{\partial A} ∇ \times \frac{\partial M}{\partial H}\end{matrix} \qquad ( 18 )$$

Because the analysis apparatus 10 cannot analytically calculate δM/δH, the analysis apparatus 10 calculates ΔM/ΔH by calculating an average value M* in which the external magnetic field is set as H=H+ΔH and using an equation ΔM=M*−M. In the calculation of ΔM/ΔH, a value ΔH obtained at the previous time step is used for ΔH. Specifically, ΔM/ΔH is calculated using Equation (19) below:

$$\frac{\partial M}{\partial H} = \frac{Δ M}{Δ H} = \frac{{M}^{n + 1} - {M}^{n}}{Δ {H}^{n}} \qquad ( 19 )$$

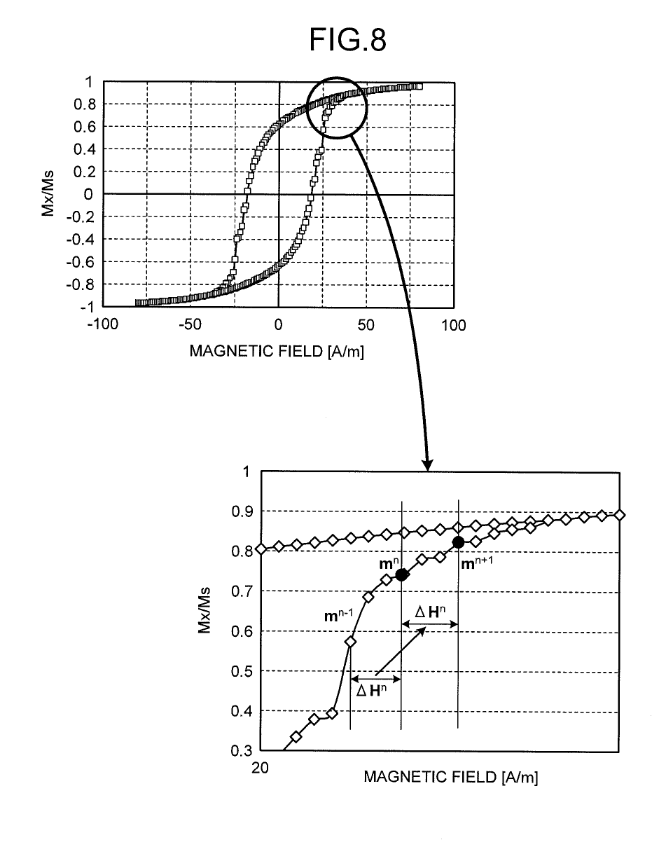

If the analysis apparatus 10 performs the calculation using Equation (17) that takes into consideration the gradient term of such an average value M, the convergence speed of δA becomes fast; therefore, it is possible to evolve, over time at a faster pace, the vector potential A and the average value M. For example, in the example illustrated in FIG. 8, the analysis apparatus 10 sets a value, which is obtained by dividing the difference between Mⁿ⁺¹ and Mⁿ by ΔHⁿ obtained at the previous time step, as the gradient of the average value M. FIG. 8 is a schematic diagram illustrating the magnetic field gradient.

Because the number of calculated average values M is finite, the M-H curves are not smooth and have minute irregularities. Because the gradient of the average values M is not accurate if the irregularities on the M-H curve are large, in some cases, the analysis apparatus 10 cannot converge δA at a high speed.

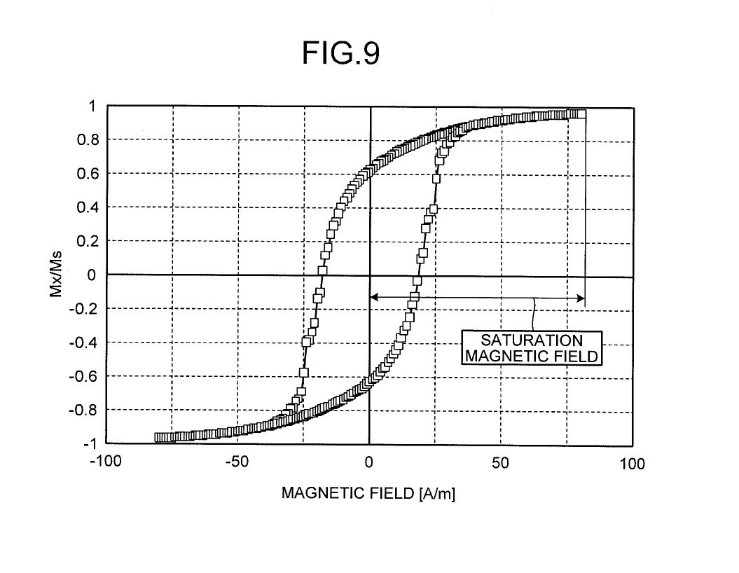

Accordingly, the analysis apparatus 10 calculates δH by dividing a saturation magnetic field of the object to be analyzed by the number of average values M. For example, the analysis apparatus 10 obtains the saturation magnetic field Hₛₐₜ illustrated in FIG. 9. FIG. 9 is a schematic diagram illustrating the saturation magnetic field.

Then, if the sum of δH and a predetermined coefficient α is smaller than ΔH, the analysis apparatus 10 estimates that the irregularities on the M-H curves are within the variation of ΔH and calculates an increment δA using Equation (17). In contrast, if the sum of δH and a predetermined coefficient α is greater than ΔH, the analysis apparatus 10 determines that the analysis apparatus 10 picks up the irregularities on the M-H curves and thus calculates the increment δA using Equation (16).

Specifically, by appropriately using Equation (8) to Equation (19) above, the analysis apparatus 10 calculates the vector potential A that is made to evolve over time using the average value M.

In the following, processes performed by each units included in the analysis apparatus 10 will be described. In the following description, it is assumed that the analysis apparatus 10 obtains, from the control device 4, m⁰ as initial values of the plurality of micro-magnetization vectors m.

Referring back to FIG. 1, the analysis apparatus 10 includes a receiving unit 11, a magnetization vector average value calculating unit 12, a vector potential calculating unit 13, an external magnetic field calculating unit 14, a micro-magnetization vector calculating unit 15, a magnetic field gradient calculating unit 16, and an output unit 17.

The receiving unit 11 receives an input of property information on an object to be analyzed. For example, if the receiving unit 11 receives, from the control unit 4, a plurality of micro-magnetization vectors m⁰ that are set by a user, the receiving unit 11 transmits, to the magnetization vector average value calculating unit 12, the obtained micro-magnetization vectors m⁰, the analysis conditions, and property information on the object to be analyzed.

The magnetization vector average value calculating unit 12 calculates, in accordance with the property information on the object to be analyzed received by the receiving unit 11, the average value M⁰ of the micro-magnetization vectors m⁰ allocated to the object to be analyzed. Specifically, the magnetization vector average value calculating unit 12 obtains, from the receiving unit 11, the micro-magnetization vectors m⁰, the analysis conditions, and the property information on the object to be analyzed. Then, using Equation (8), the magnetization vector average value calculating unit 12 calculates the average value M⁰ from the obtained micro-magnetization vectors m⁰. Thereafter, the magnetization vector average value calculating unit 12 transmits, to the vector potential calculating unit 13, the calculated average value M⁰, the analysis conditions, and the property information on the object to be analyzed.

Furthermore, if the magnetization vector average value calculating unit 12 obtains a plurality of micro-magnetization vectors mⁿ calculated by the micro-magnetization vector calculating unit 15, which will be described later, the magnetization vector average value calculating unit 12 calculates an average value Mⁿ of the obtained micro-magnetization vectors m. Then, the magnetization vector average value calculating unit 12 transmits the calculated average value Mⁿ to the vector potential calculating unit 13.

By using the average value M calculated by the magnetization vector average value calculating unit 12 and using an equation of the magnetic field that is a governing equation of the vector potential A, the vector potential calculating unit 13 calculates a vector potential A obtained after a predetermined time has elapsed.

In the following, a process performed by the vector potential calculating unit 13 will be specifically described. The first thing described in the following description will be a process in which the vector potential calculating unit 13 determines whether it treats the average value M explicitly or implicitly. Then, a process performed when the average value M is explicitly treated will be described, and then a process performed when the average value M is implicitly treated will be described.

First, a process in which the vector potential calculating unit 13 determines whether it treats the average value M explicitly or implicitly will be described. For example, the vector potential calculating unit 13 obtains, from the micro-magnetization vector calculating unit 15, the average value M⁰, the analysis conditions, and the property information on the object to be analyzed.

Then, when the vector potential calculating unit 13 obtains both the analysis conditions and the property information on the object to be analyzed, the vector potential calculating unit 13 determines, in accordance with the obtained analysis conditions and the property information on the object to be analyzed, the time scale over which both the LLG equation and the equation of the magnetic field evolve. Then, if the time scale over which both the LLG equation and the equation of the magnetic field evolve is shorter than a predetermined threshold, the vector potential calculating unit 13 determines to explicitly treat the average value M. In contrast, if the time scale over which both the LLG equation and the equation of the magnetic field evolve is greater than a predetermined threshold, the vector potential calculating unit 13 determines to implicitly treat the average value M.

In the following, a process in which the vector potential calculating unit 13 explicitly treats the average value M will be specifically described. If the vector potential calculating unit 13 explicitly treats the average value M, the vector potential calculating unit 13 solves, using the average value M⁰ obtained from the magnetization vector average value calculating unit 12, Equation (10) and calculates the vector potential A¹ obtained after a predetermined time has elapsed. Then, the vector potential calculating unit 13 transmits the calculated vector potential A¹ to the external magnetic field calculating unit 14.

Furthermore, the vector potential calculating unit 13 obtains a new average value M (for example, an average value Mⁿ at the n^{th} time step) calculated by the magnetization vector average value calculating unit 12. Then, the vector potential calculating unit 13 solves Equation (10) using the average value Mⁿ and calculates the vector potential Aⁿ⁺¹ obtained after a predetermined time has elapsed. Then, the vector potential calculating unit 13 transmits the calculated vector potential Aⁿ⁺¹ to the external magnetic field calculating unit 14.

In the following, a process in which the vector potential calculating unit 13 implicitly treats the average value M will be specifically described. First, if the vector potential calculating unit 13 determines to implicitly treat the average value M, the vector potential calculating unit 13 calculates the above-described δH and ΔH and determines whether the sum of the calculated δH and a predetermined coefficient α (for example, α=“3”) is greater than ΔH.

If the vector potential calculating unit 13 determines that the sum of δH and the predetermined coefficient α is greater than ΔH, the vector potential calculating unit 13 solves Equation (16) using the average value M⁰ and calculates an increment δA of the vector potential. Then, the vector potential calculating unit 13 transmits the calculated δA to the magnetic field gradient calculating unit 16.

In contrast, if the vector potential calculating unit 13 determines that the sum of δH and the predetermined coefficient is smaller than ΔH, the vector potential calculating unit 13 obtains the magnetic field gradient from the magnetic field gradient calculating unit 16, which will be described later. Then, by solving Equation (17) using the obtained magnetic field gradient and the average value M⁰, the vector potential calculating unit 13 calculates the increment δA of the vector potential. Then, the vector potential calculating unit 13 transmits the calculated δA to the magnetic field gradient calculating unit 16.

Furthermore, when the vector potential calculating unit 13 calculates the increment δA of the vector potential, the vector potential calculating unit 13 determines whether the absolute value of the calculated increment δA is smaller than the predetermined threshold ε. If the vector potential calculating unit 13 determines that the absolute value of the calculated increment ΔA is greater than the predetermined threshold ε, the vector potential calculating unit 13 calculates a new vector potential Aⁿ⁺¹₁ by adding the vector potential Aₙ₊₁₀ to the increment δA.

Furthermore, if the vector potential calculating unit 13 calculates the new vector potential Aⁿ⁺¹₁, the vector potential calculating unit 13 calculates, by solving Equation (1), Equation (6), and Equation (8) using the calculated vector potential Aⁿ⁺¹₁, a new average value M₁. Then, the vector potential calculating unit 13 solves, using the average value M₁, Equation (16) so that it calculates an increment δA of the new vector potential. The vector potential calculating unit 13 repeatedly performs a series of calculations until the absolute value of the increment δA of the vector potential becomes smaller than the predetermined threshold ε.

In contrast, if the vector potential calculating unit 13 determines that the absolute value of the increment δA is smaller than the predetermined threshold ε, the vector potential calculating unit 13 transmits, as the vector potential Aⁿ⁺¹ to the external magnetic field calculating unit 14, Aⁿ⁺¹ᵢ calculated in the previous repeated calculation (for example, calculated at the i^{th} time). Furthermore, the vector potential calculating unit 13 transmits, as the vector potential Aⁿ⁺¹ to the magnetic field gradient calculating unit 16, the calculated Aⁿ⁺¹ᵢ.

In this way, the vector potential calculating unit 13 calculates, using the average value M, a vector potential A at the subsequent time step. Furthermore, as described above, the average value M can be assumed to be stationary with respect to the vector potential A. Accordingly, the vector potential calculating unit 13 can calculate the vector potential A using a long time step.

The external magnetic field calculating unit 14 calculates, in accordance with the vector potential A calculated by the vector potential calculating unit 13, the external magnetic field H formed around the magnetic material. For example, the external magnetic field calculating unit 14 obtains the vector potential A¹ that is transmitted by the vector potential calculating unit 13. Then, the external magnetic field calculating unit 14 solves Equation (6) using the obtained vector potential A¹ so that it calculates the external magnetic field H¹. Then, the external magnetic field calculating unit 14 transmits the calculated external magnetic field H¹ to the micro-magnetization vector calculating unit 15.

The micro-magnetization vector calculating unit 15 calculates, in accordance with the external magnetic field H calculated by the external magnetic field calculating unit 14, new micro-magnetization vectors m used for the magnetic material. For example, the micro-magnetization vector calculating unit 15 obtains the external magnetic field H¹ transmitted by the external magnetic field calculating unit 14. Then, by using the obtained external magnetic field H¹, the micro-magnetization vector calculating unit 15 solves Equation (1) for each mesh of the magnetic material so that it calculates new micro-magnetization vectors m¹. Then, the micro-magnetization vector calculating unit 15 transmits the calculated micro-magnetization vectors m¹ to the output unit 17 and the magnetization vector average value calculating unit 12.

Specifically, using each unit 12 to 15, the analysis apparatus 10 calculates the average value Mⁿ of the micro-magnetization vectors mⁿ and calculates, from the calculated average value Mⁿ, a vector potential Aⁿ⁺¹ that is made to evolve, to the subsequent time step, over time. Then, the analysis apparatus 10 calculates, from the calculated vector potential Aⁿ⁺¹, an external magnetic field Hⁿ⁺¹ and calculates, from the calculated external magnetic field Hⁿ⁺¹, new micro-magnetization vectors mⁿ⁺¹. By repeatedly performing this process, the analysis apparatus 10 can solve the LLG equation and the equation of the magnetic field as both the micro-magnetization vector m and the vector potential A evolve over time.

The magnetic field gradient calculating unit 16 calculates the magnetic field gradient by dividing the increment of the average value M by the increment of the external magnetic field H. For example, the magnetic field gradient calculating unit 16 obtains both the increment δA and the vector potential Aⁿ⁺¹ calculated by the vector potential calculating unit 13. Then, if repeated calculations according to the implicit method are not performed, the magnetic field gradient calculating unit 16 calculates ΔH using Equation (20) below:

$$Δ H = \frac{1}{{μ}_{0}} ∇ \times δ A \qquad ( 20 )$$

Furthermore, if repeated calculations according to the implicit method are performed multiple times (for example, n times), the magnetic field gradient calculating unit 16 calculates ΔH by solving Equation (21) using both the obtained Aⁿ⁺¹ and the previously obtained Aⁿ.

$$Δ H = \frac{1}{{μ}_{0}} ∇ \times ( {A}^{n + 1} - {A}^{n} ) \qquad ( 21 )$$

Furthermore, the magnetic field gradient calculating unit 16 calculates, from the previously obtained Aⁿ, an external magnetic field Hⁿ and calculates H* that is the sum of the calculated Hⁿ and ΔH. Furthermore, the magnetic field gradient calculating unit 16 solves Equation (1) and Equation (8) using the calculated H* and Hⁿ and calculates the average value M* and the average value Mⁿ. Thereafter, the magnetic field gradient calculating unit 16 calculates the difference δM between the calculated average value M* and the average value Mⁿ. Then, the magnetic field gradient calculating unit 16 transmits, to the vector potential calculating unit 13, ΔM/ΔH as the magnetic field gradient.

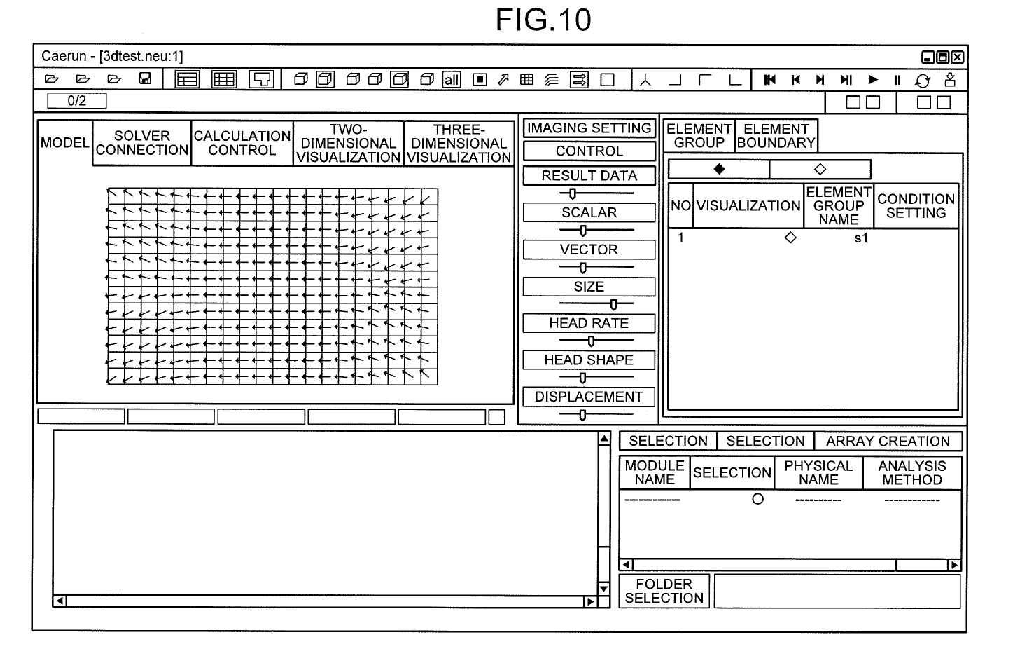

The output unit 17 outputs the new micro-magnetization vectors m calculated by the micro-magnetization vector calculating unit 15. For example, the output unit 17 obtains, from the micro-magnetization vector calculating unit 15, the micro-magnetization vectors m¹ to mⁿ⁺¹. Then, as illustrated in FIG. 10, the output unit 17 creates, in accordance with the obtained micro-magnetization vectors m¹ to mⁿ⁺¹, an image in which the properties of the magnetic material are simulated. Then, the output unit 17 displays, on the monitor 6 by using the control unit 4, the created image. FIG. 10 is a schematic diagram illustrating an example of output results.

For example, the control unit 4 and the analysis apparatus 10 are electronic circuits. Furthermore, the receiving unit 11, the magnetization vector average value calculating unit 12, the vector potential calculating unit 13, the external magnetic field calculating unit 14, the micro-magnetization vector calculating unit 15, the magnetic field gradient calculating unit 16, and the output unit 17 are electronic circuits. In the embodiments, examples of the electronic circuit include an integrated circuit, such as an application specific integrated circuit (ASIC) or a field programmable gate array (FPGA), a central processing unit (CPU), and a micro processing unit (MPU).

The memory 2 is a semiconductor memory device, such as a random access memory (RAM), a read only memory (ROM), and a flash memory, or it is a storing unit, such as a hard disc drive and an optical disk.

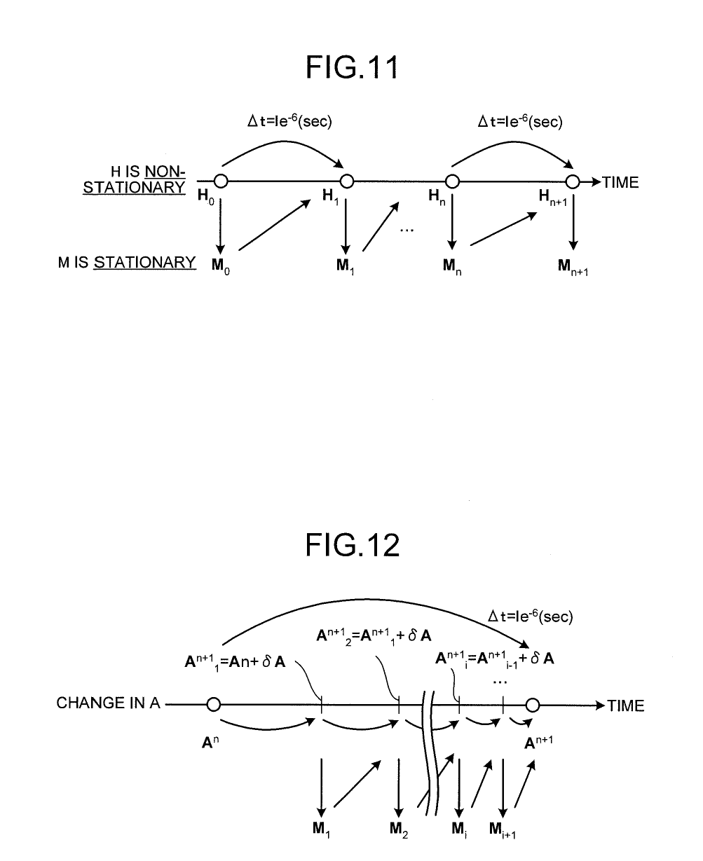

In the following, a process, performed by the analysis apparatus 10, for evolving the external magnetic field H over time by using an explicit expression M will be described with reference to FIG. 11. FIG. 11 is a schematic diagram illustrating an example of a process for evolving time by using the explicit expression M. In the example illustrated in FIG. 11, the analysis apparatus 10 calculates, from a stationary average value M⁰, a non-stationary external magnetic field H¹ obtained after 10⁻⁶ seconds and calculates, from the calculated external magnetic field H¹, a stationary average value M¹. Accordingly, because the analysis apparatus 10 calculates the external magnetic field H that is made to evolve over time by using the average value M, the analysis apparatus 10 can evolve the time for a longer time scale than the conventional information processing apparatus that calculates a micro-magnetization vector m that is made to evolve over time by using the external magnetic field H.

In the following, a process, performed by the analysis apparatus 10, for evolving the vector potential A over time using an implicit expression M will be described with reference to FIG. 12. FIG. 12 is a schematic diagram illustrating an example of a process for evolving time by using the implicit expression M. In the example illustrated in FIG. 12, the analysis apparatus 10 calculates, using Aⁿ⁺¹₁=Aⁿ+δA, a stationary state M, and calculates, from the calculated M₁, Aⁿ⁺¹₂=Aⁿ₁+δA. By repeatedly performing such calculations until δA becomes equal to or less than a predetermined threshold ε, the analysis apparatus 10 can calculate, from Aⁿ, Aⁿ⁺¹ after 10⁻⁶ seconds.

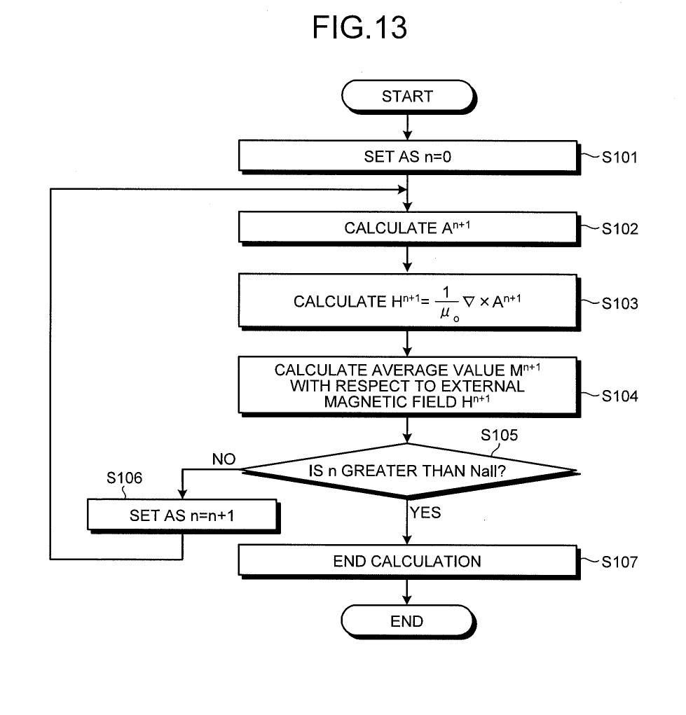

In the following, there will be a description, with reference to FIG. 13, of the flow of a process, performed by the analysis apparatus 10, in which time evolves by using the explicit expression M. FIG. 13 is a flowchart illustrating the flow of a process for evolving time by using the explicit expression M.

First, the analysis apparatus 10 initializes, to “0”, n that represents the number of times that time is made to evolve (Step S101). Then, the analysis apparatus 10 solves Equation (10) using an average value Mⁿ and calculates a vector potential Aⁿ⁺¹ (Step S102). Subsequently, the analysis apparatus 10 solves Equation (6) using the calculated vector potential Aⁿ⁺¹ and calculates an external magnetic field Hⁿ⁺¹ (Step S103). Furthermore, the analysis apparatus 10 solves, using the calculated external magnetic field Hⁿ⁺¹, Equation (1) and Equation (8) and calculates an average value Mⁿ⁺¹ of the micro-magnetization vectors with respect to the external magnetic field Hⁿ⁺¹ (Step S104).

Then, the analysis apparatus 10 determines whether the number of times n that time is made to evolve is greater than a predetermined value “Nall” (Step S105). Here, Nall is, for example, the time scale for evolving both the micro-magnetization vector m and the vector potential A over time and is a value divided by the period of time for simulating the properties of the magnetic material set by a user. If the analysis apparatus 10 determines that the number of times n that time is made to evolve is smaller than a predetermined value “Nall” (No at Step S105), the analysis apparatus 10 adds “1” to n (Step S106) and calculates a new vector potential Aⁿ⁺¹ (Step S102).

In contrast, if the analysis apparatus 10 determines that the number of times n that time is made to evolve is greater than the predetermined value “Nall” (Yes at Step S105), the analysis apparatus 10 ends the calculation (Step 5107) and then ends the process.

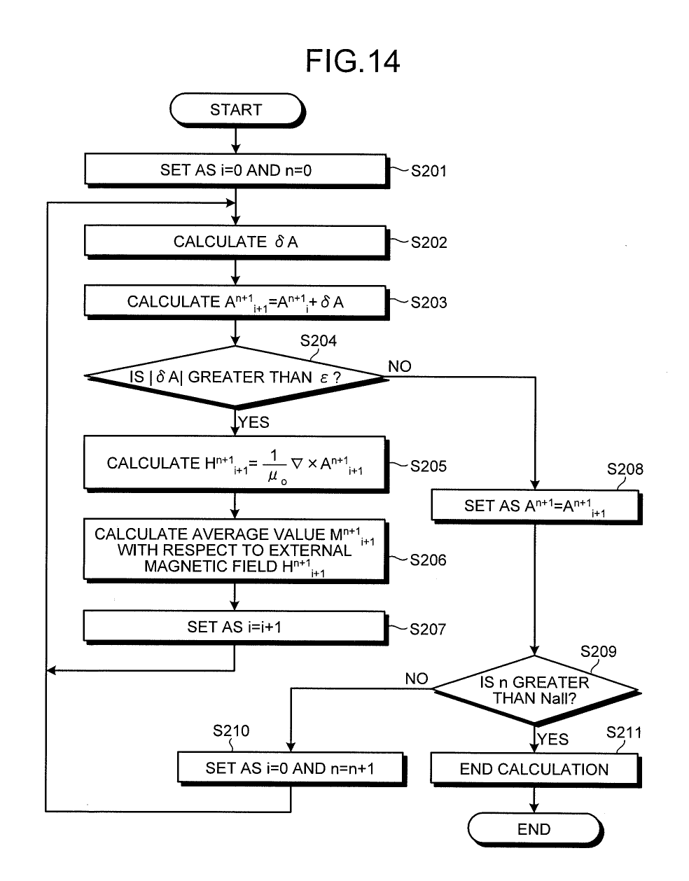

In the following, there will be a description, with reference to FIG. 14, of the flow of a process, performed by the analysis apparatus 10, in which time evolves by using an implicit expression M. FIG. 14 is a flowchart illustrating the flow of a process for evolving time by using the implicit expression M. In the example illustrated in FIG. 14, it is assumed that the analysis apparatus 10 repeatedly performs calculations without using a magnetic field gradient.

First, the analysis apparatus 10 initializes, to “0”, both i that is the number of repeated calculations and n that represents the number of times that time is made to evolve (Step S201). Then, the analysis apparatus 10 solves Equation (16) using the average value Mⁿ and calculates δA (Step S202). The analysis apparatus 10 then calculates Aⁿ⁺¹ᵢ₊₁=Aⁿ⁺¹ᵢ+δA (Step S203). Furthermore, the analysis apparatus 10 determines whether the absolute value of δA is greater than the predetermined threshold ε (Step S204).

If the analysis apparatus 10 determines that the absolute value of δA is greater than the predetermined threshold ε (Yes at Step S204), the analysis apparatus 10 solves Equation (6) using Aⁿ⁺¹ᵢ₊₁ and calculates an external magnetic field Hⁿ⁺¹₁₊₁ (Step S205). Then, the analysis apparatus 10 solves, using the external magnetic field Hⁿ⁺¹ᵢ₊₁, Equation (1) and Equation (8) and calculates an average value Mⁿ⁺¹₁₊₁ of the micro-magnetization vectors with respect to the external magnetic field Hⁿ⁺¹ᵢ₊₁ (Step S206). By adding “1” to i (Step S207), the analysis apparatus 10 solves Equation (16) using Mⁿ⁺¹ᵢ₊₁ and again calculates δA (Step S202).

In contrast, if the analysis apparatus 10 determines that the absolute value of δA is smaller than the predetermined threshold ε (No at Step S204), the analysis apparatus 10 sets Aⁿ⁺¹ᵢ₊₁ as Aⁿ⁺¹ (Step S208). Specifically, if the analysis apparatus 10 determines that the absolute value of δA is smaller than the predetermined threshold ε, the analysis apparatus 10 sets, as the result of repeated calculations with respect to δ, the calculated Aⁿ⁺¹ᵢ₊₁ as a new vector potential Aⁿ⁺¹. Then, the analysis apparatus 10 determines whether the number of times n that time is made to evolve is greater than the predetermined value “Nall” (Step S209).

If the analysis apparatus 10 determines that the number of times n that time is made to evolve is smaller than the predetermined value “Nall” (No at Step S209), the analysis apparatus 10 adds “1” to n and initializes i to “0” (Step S210). Thereafter, the analysis apparatus 10 again calculates δA (Step S202). Furthermore, if the analysis apparatus 10 determines that the number of times n that time is made to evolve is greater than the predetermined value “Nall” (Yes at Step S209), the analysis apparatus 10 ends the calculation (Step S211) and then ends the process.

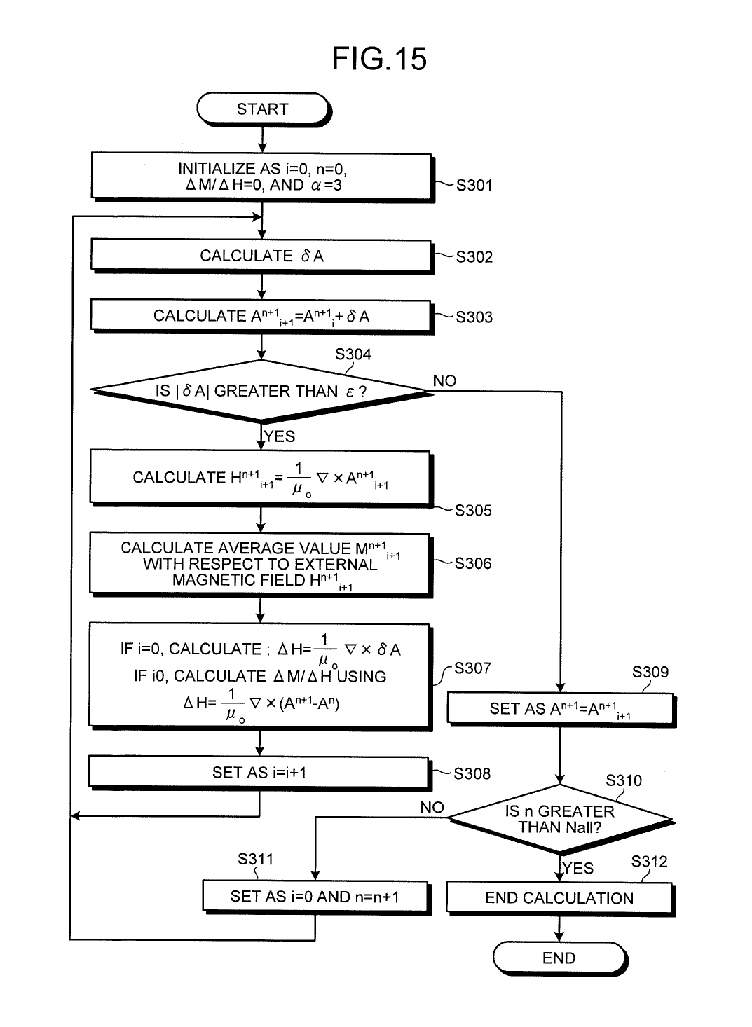

In the following, there will be a description, with reference to FIG. 15, of a process, performed by the analysis apparatus 10, in which time evolves by using both the magnetic field gradient and the implicit expression M. FIG. 15 is a flowchart illustrating the flow of a process, in which time evolves, using a magnetic field gradient. In the process illustrated in FIG. 15, Steps S302 to S306 and S308 are the same as Steps S202 to S206 and S207 illustrated in FIG. 14; therefore, descriptions thereof will be omitted. Furthermore, Steps S309 to S312 are the same as Steps S208 to S211 illustrated in FIG. 14; therefore, descriptions thereof will be omitted.

First, the analysis apparatus 10 initializes i, which is the number of repeated calculations, to “0”; initializes n, which represents the number of times that time is made to evolve, to “0”; and initializes AM/AH, which is the magnetic field gradient, to “0”; and initializes the predetermined coefficient α to “3” (Step S301). Furthermore, if i is “0”, the analysis apparatus 10 calculates ΔH using Equation (20), whereas if i is not “0”, the analysis apparatus 10 calculates ΔH using Equation (21). Then, the analysis apparatus 10 calculates the magnetic field gradient ΔM/ΔH using the calculated ΔH (Step S307).

### Advantage of First Embodiment

As described above, the information processing apparatus 1 according to the first embodiment calculates an average value Mⁿ of a plurality of micro-magnetization vectors m allocated to the magnetic material that corresponds to the object to be analyzed. Then, by using the calculated average value Mⁿ and the equation of the magnetic field that is the governing equation of the vector potential, the information processing apparatus 1 calculates a vector potential Aⁿ⁺¹ at the subsequent time step. Accordingly, the information processing apparatus 1 can evolve both the LLG equation and the equation of the magnetic field over time for a long time scale, thus simulating the properties of the magnetic material over a long period of time.

Furthermore, by using Equation (10) that explicitly represents the average value M of the magnetization vectors that is derived from both LLG Equation (1) and from Equation (7) of the magnetic field and by using the average value Mⁿ of the magnetization vector, the information processing apparatus 1 calculates a vector potential Aⁿ⁺¹ obtained after a predetermined time has elapsed. Accordingly, the information processing apparatus 1 can calculate, in a single calculation, the vector potential Aⁿ⁺¹ at the subsequent time step. As a result, because the information processing apparatus 1 reduces the amount of calculation in which both the LLG equation and the equation of the magnetic field are made to evolve over time, the information processing apparatus 1 can simulate the properties of the magnetic material over a further longer period of time.

Furthermore, by using Equation (13) that implicitly represents the average value M of the magnetization vectors derived from LLG Equation (1) and from Equation (7) of the magnetic field and by using the average value Mⁿ of the micro-magnetization vectors, the information processing apparatus 1 calculates the increment δA of the vector potential. Then, in accordance with the calculated increment δA of the vector potential, the information processing apparatus 1 calculates the vector potential Aⁿ⁺¹ at the subsequent time step. Accordingly, even when the implicit method is used, the information processing apparatus 1 can evolve the LLG equation and the equation of the magnetic field over time for a long time scale. As a result, it is possible to accurately simulate the properties of the magnetic material for a long period of time.

Furthermore, during the process for evolving time from Aⁿ to Aⁿ⁺¹, when repeatedly performing calculations according to the implicit method, the information processing apparatus 1 calculates, from the average value Mⁿᵢ of the micro-magnetization vectors, the increment δA of the vector potential. Then, the information processing apparatus 1 calculates, in accordance with the calculated increment δA of the vector potential, a new vector potential Aⁿ⁺¹ᵢ₊₁.

Specifically, in the repeated calculations of the vector potential from Aⁿ to Aⁿ⁺¹, the information processing apparatus 1 calculates, from the vector potential Aⁿ⁺¹₀, Aⁿ⁺¹ᵢ₊₁ by assuming each of the average values Mⁿ₀ to Mⁿᵢ₊₁ of the micro-magnetization vectors to be stationary. Accordingly, in each Step of the repeated calculations according to the implicit method, the information processing apparatus 1 can evolve both the LLG equation and the equation of the magnetic field for a longer time scale, thus further extending the period of time for simulating the properties of the magnetic material.

Furthermore, the information processing apparatus 1 speeds up, using the magnetic field gradient ΔM/ΔH, the convergence of δA in the repeated calculations. Accordingly, the information processing apparatus 1 can reduce the number of repeated calculations according to the implicit method; therefore, it is possible for the information processing apparatus 1 to reduce the amount of calculation and to further extend the period of time for simulating the properties of the magnetic material.

Furthermore, if the sum of a predetermined coefficient α and δH, where δH is obtained by dividing the saturation magnetic field Hₛₐₜ by the number of micro-magnetization vectors m allocated to the magnetic material, is greater than the increment ΔH of the external magnetic field, the information processing apparatus 1 performs a calculation using the magnetic field gradient ΔM/ΔH. Specifically, if the sum of δH and α is greater than the increment ΔH of the external magnetic field, irregularities produced on the M-H curve are large; therefore, the gradient of the average values M is not accurate. Accordingly, if the sum of ΔH and the predetermined coefficient α is smaller than the increment ΔH of the external magnetic field, the information processing apparatus 1 can use the appropriate magnetic field gradient ΔM/ΔH. As a result, the information processing apparatus 1 can appropriately speed up the convergence of δA in the repeated calculations.

[b] Second Embodiment

The embodiments of the present invention have been described; however, the present invention is not limited to the embodiments described above and can be implemented with various kinds of embodiments other than the embodiments described above. Accordingly, another embodiment included in the present invention will be described as a second embodiment.

(1) Predetermined Coefficient α

If the sum of δH and the predetermined coefficient α is smaller than ΔH, the analysis apparatus 10 according to the first embodiment described above estimates that the irregularities on the M-H curves are within the variation of ΔH. When evolving time using the magnetic field gradient and the implicit expression M, the analysis apparatus 10 initializes a predetermined coefficient α to “3”; however, the embodiment is not limited thereto. The predetermined coefficient α can be another value. For example, predetermined coefficient α can be a value that can appropriately be changed in accordance with the properties of the magnetic material that is the object to be analyzed or changed in accordance with the number of micro-magnetization vectors m allocated to the magnetic material.

(2) Time Scale Over Which Time Evolves

The analysis apparatus 10 according to the first embodiment described above evolves both the LLG equation and the equation of the magnetic field over time at time intervals of 10⁻⁶; however, the embodiment is not limited thereto. Any given time step can be used so long as the vector potential A can be accurately calculated at the subsequent time step. Furthermore, for example, the time scale of the time step can be changed for each calculation. For example, the analysis apparatus 10 can evolve both the LLG equation and the equation of the magnetic field over time for a given time scale between approximately 10⁻⁶ and 10⁻¹² seconds.

(3) Information processing apparatus

The information processing apparatus 1 according to the first embodiment has a single analysis apparatus 10; however, the embodiment is not limited thereto. For example, an information processing apparatus 1a according to the second embodiment has a plurality of analysis apparatuses 10A to 10Z that have the same function as that performed by the analysis apparatus 10. If the size of the magnetic material that is the object to be analyzed is large, the information processing apparatus la divides the magnetic material into regions A to Z and allows the analysis apparatuses 10A to 10Z to perform a parallel calculation of the properties of each of the divided regions A to Z.

Calculating the average value M from the micro-magnetization vectors m can be independently performed for each of the regions A to Z. Accordingly, the information processing apparatus 1a can accurately calculate, in a short period of time, the properties of the magnetic material that is the object to be analyzed over a long period of time.

(4) Program

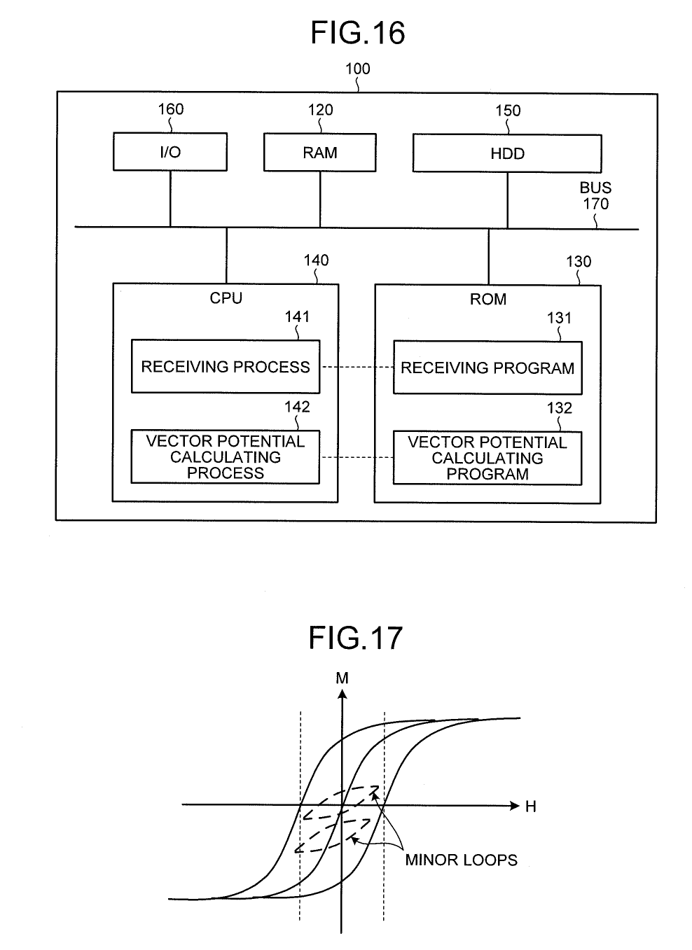

With the analysis apparatus 10 according to the first embodiment, a case in which various processes are implemented using hardware has been described; however, the embodiments are not limited thereto. For example, it is possible to implement an analysis program prepared in advance and executed by a computer. Accordingly, in the following, a computer that executes the analysis program having the same functions as those performed by the analysis apparatus 10 described in the first embodiment will be described as an example with reference to FIG. 16. FIG. 16 is a functional block diagram illustrating a computer that executes the analysis program.

In a computer 100 illustrated in FIG. 16, a random access memory (RAM) 120, a read only memory (ROM) 130, and a hard disk drive (HDD) 150 are connected via a bus 170. Furthermore, in the computer 100 illustrated in FIG. 16, a central processing unit (CPU) 140 is connected via the bus 170. Furthermore, an input/output (I/O) 160 that receives an input from a user is connected to the bus 170.

The ROM 130 stores therein, in advance, a receiving program 131 and a vector potential calculating program 132. In the example illustrated in FIG. 16, the CPU 140 reads each of the programs 131 and 132 from the ROM 130 and executes them so that the programs 131 and 132 functions as a receiving process 141 and a vector potential calculating process 142, respectively. Furthermore, each of the processes 141 and 142 has the same function, respectively, as that performed by the units 11 and 12 illustrated in FIG. 1. Each of the processes 141 and 142 can also have the same function as that performed by each unit according to the second or third embodiment.

The analysis program in the embodiments can be implemented by a program prepared in advance and executed by a computer, such as a personal computer or a workstation. The program can be sent using a network such as the Internet. Furthermore, the program can be stored in a computer-readable recording medium, such as a hard disc drive, a flexible disk (FD), a compact disc read only memory (CD-ROM), a magneto optical disc (MO), and a digital versatile disc (DVD). Furthermore, the program can also be implemented by the computer reading it from the recording medium.

According to an embodiment, it is advantageously possible to simulate the properties of magnetic materials for a long period of time.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An analysis apparatus comprising:
a receiving unit that receives a property information on an object to be analyzed; and
a vector potential calculating unit that calculates an average value of a plurality of magnetization vectors allocated to each region of the object that is obtained by dividing the object to be analyzed in accordance with the received property information of the object to be analyzed, and calculates a vector potential obtained after a predetermined time has elapsed by using the calculated average value of the magnetization vectors and an equation of a magnetic field that is a governing equation of a vector potential.

2. The analysis apparatus according to claim 1, wherein the vector potential calculating unit calculates the vector potential obtained after the predetermined time has elapsed by using the calculated average value of the magnetization vectors and an equation that explicitly represents the average value of the magnetization vectors that is derived from an equation of motion that represents a change in a magnetization vector and the equation of the magnetic field.

3. The analysis apparatus according to claim 1, wherein the vector potential calculating unit calculates an increment of a vector potential by using the calculated average value of the magnetization vectors, an equation that implicitly represents the average value of the magnetization vectors and that is derived from an equation of motion that represents a change in a magnetization vector and the equation of the magnetic field, and calculates the vector potential obtained after the predetermined time has elapsed in accordance with the calculated increment of the vector potential.

4. The analysis apparatus according to claim 3, wherein
the vector potential calculating unit repeatedly performs a series of calculations in which a new vector potential is calculated in accordance with the increment of the vector potential, a new average value of magnetization vectors is calculated by using the calculated new vector potential, and a new increment of a vector potential is calculated by using the calculated new average value of the magnetization vectors and the equation that implicitly represents the calculated average value of the magnetization vectors, the series of calculations being repeatedly performed until the new increment of the vector potential becomes equal to or less than a predetermined threshold, and
the vector potential calculating unit sets a new vector potential which is calculated in an immediately previous calculation in the calculations repeatedly performed as the vector potential obtained after the predetermined time has elapsed when the new increment of the vector potential becomes equal to or less than the predetermined threshold.

5. The analysis apparatus according to claim 3, further comprising a magnetic field gradient calculating unit that calculates a magnetic field gradient by dividing an increment of the calculated average value of the magnetization vectors by an increment of a magnetic field formed around the object to be analyzed, wherein
the vector potential calculating unit calculates the increment of the vector potential by using the equation that implicitly represents the calculated average value of the magnetization vectors, the calculated average value of the magnetization vectors, and the calculated magnetic field gradient.

6. The analysis apparatus according to claim 5, wherein
the vector potential calculating unit calculates the increment of the vector potential when a sum of a predetermined coefficient and a value obtained by dividing a saturation magnetic field of the object to be analyzed by the number of magnetization vectors allocated to the object to be analyzed is smaller than the increment of the magnetic field, by using the equation that implicitly represents the calculated average value of the magnetization vectors, the calculated average value of the magnetization vectors, and the magnetic field gradient and
the vector potential calculating unit calculates when the sum of the predetermined coefficient and a value obtained by dividing the saturation magnetic field of the object to be analyzed by the number of magnetization vectors is greater than the increment of the magnetic field, by using the equation that implicitly represents the calculated average value of the magnetization vectors, the calculated average value of the magnetization vector, and the increment of the vector potential.

7. An analysis method comprising:
calculating an average value of a plurality of magnetization vectors allocated to each region of the object that is obtained by dividing the object to be analyzed; and
calculating a vector potential obtained after a predetermined time has elapsed by using the calculated average value of the magnetization vectors and an equation of a magnetic field that is a governing equation of a vector potential.

8. A computer-readable, non-transitory medium storing an analysis program causing a computer to execute a process, the process comprising:
calculating an average value of magnetization vectors allocated to each region that is obtained by dividing the object to be analyzed; and
calculating a vector potential obtained after a predetermined time has elapsed by using the calculated average value of the magnetization vectors and an equation of a magnetic field that is a governing equation of a vector potential.
